(19) United States
(12) Patent Application Publication
(10) Pub. No.: US 2019/0118207 A1
(43) Pub. Date: Apr. 25, 2019

(54) DEVICE FOR DISCHARGING MULTI-COMPONENT ADHESIVES ONTO A GRANULAR MIXTURE DISCHARGING METHOD, AND USE OF THE DEVICE

(71) Applicant: HÜRLIMANN RAILTEC AG, lllnau (CH)

(72) Inventor: Adrian Huerlimann, Illnau (CH)

(73) Assignee: HUERLIMANN BAUTENSCHUTZ AG, Illnau (CH)

(21) Appl. No.: 16/093,647

(22) PCT Filed: Apr. 19, 2017
(86) PCT No.: PCT/EP2017/059253

§ 371 Date: Oct. 14, 2018

(30) Foreign Application Priority Data
Apr. 19, 2016 (CH) 00515/16

(51) Int. Cl. B05B 12/14; B05B 12/12; B60F 1/00; B61D 15/00; E01B 37/00

(52) U.S. Cl. CPC B05B 12/1436; B05B 12/126; B60F 1/00; B05B 1/20; E01B 37/00; E01B 2204/03; E01B 2203/14; B61D 15/00

(57) ABSTRACT

An apparatus for discharging multi-component adhesives of at least two fluidic components onto a granular ballast bed of a railway rail train includes of at least two separate carriages, which can be transferred into a vehicle or a trailer by having the vehicle or the trailer equipped on the inside with rails onto which the carriages can be rolled. The wagons can thus be transported by road to the usage site and can be put into operation by placing them from the trailer onto the tracks of the railway track using extendable rails. The apparatus allows the fully automatic spreading of adhesives over long distances to a ballast bed, so that the ballast bed is bonded in so that trains can continue to run normally. The entire apparatus can be loaded, transported and unloaded on site and put into operation by just two persons.

The invention relates to a device for discharging multi-component adhesive having at least two fluidic components onto a granular mixture, in particular for discharging multi-component adhesives onto the ballast of a rail track. In the process, the two fluidic components are controllably conveyed by a mixer unit from storage tanks at precisely controllable flow rates via two separate feed lines by means of gear pumps, whereby a sprayable fluidic adhesive mixture is created. A spray unit with a spray bar with several discharge nozzles serves for the targeted discharge of the adhesive mixture onto the ballast bed. Furthermore, the invention relates to a process for applying this device and its use for discharging multi-component adhesives onto the ballast of an railway rail track.

Today, railways are an important component of both long-distance and local mass-transit infrastructure. It is not always possible for the rail superstructure to cope with the increasing traffic load. With increasing speed, higher traffic loads or higher usage intensity, weaknesses of the different types of construction become apparent. In addition to regular maintenance, track renewal is a necessary measure to meet the increased demands. The ballasted track is the dominant track bed structure for long-distance traffic. However, in mass transit, on bridges or in tunnels, one finds the formation of a solid roadway. Bonding systems offer an efficient solution for both designs and for connecting different running tracks. For ballasted tracks as a line, the loosely laid track length of rails and sleepers lies in this unbound, compacted ballast bed without lateral attachment. The ballast bed can absorb considerable compressive forces, but can be displaced only to a limited extent under tensile loads. Bonding systems ensure fast and durable position stability in difficult areas such as rail joints or turnouts. Special measures are required to secure the position of the ballast bed during reconstruction work and track renewal on multi-track lines. The bonding of the ballast shoulders using two-component resin-hardener mixtures has proven to be an effective method for this. Compared to conventional shoring measures, the application of a fast-hardening bonding system saves a great deal of time and money. A particularly difficult area for railways is the integration of different types of construction. Transitions between a ballasted track and a rigid track are problematic due to the different settlement behavior. Here the graduated bonding of the ballast has proven to be an effective measure for adapting different elasticities. Here, too, bonding systems offer special advantages, namely short waiting times until load-bearing capacity and very good environmental compatibility of the bonding system. For the inner-urban mass transit, primarily rigid tracks and grassed tracks shape the image of the railways. For these embodiments, too, the two-component mixtures offer efficient and detailed solutions for stabilizing, sealing and designing the trackage.

The bonding of granular mixtures is therefore used today in a wide variety of areas. In track construction, mainly coarse-grained rock fills and gravel are bonded, while in road construction, besides coarse-grained rock fills also smaller-grained rock fills and grit are used. Even finer mixtures are used, for example, for bonding decorative top floor coatings. Despite the stabilization by bonding the coating, its water permeability or seepage capacity can be maintained. The bonding of ballast in track construction is of particular importance. Today, mostly two-component adhesives on polyurethane basis are used for this purpose. Such multi-component adhesives on polyurethane basis are known in the prior art, for instance from WO 2011/110489A1. Devices for the controlled pumping, measuring out, mixing and spreading of such adhesives, among other things with the aid of gear pumps, are also known in principle, for example from CN 101 850 312 A, DE 196 32 638 A1 or WO 2014/176589 A1.

Various positive effects are achieved in track construction by bonding ballast. Among other things, it enables the stabilization of the tracks and the reduction of impacts at rail joints of the ballasted track to the rigid track, for example at tunnel entrances and exits. For this purpose, the ballast is usually bonded over its entire surface, i.e. also under the rails and sleepers. In order to achieve a reduction of the joints at the transitions between ballast and rigid track, the penetration depth of the bonding to the rigid track is gradually increased. A bonding of the ballast not only improves the driving comfort but also the durability of the track, as shifting of the stones is prevented.

A bonding of the ballast bed at the edge of a railway line is often of decisive importance if a trench is to be dug near the rail line, or in general if material is to be excavated next to the rail line as a result of a construction project, such as the laying of further parallel rail line or a building, a retaining wall etc., or due to other structural measures. Otherwise, such an excavation will weaken the ballast bed and its load-bearing capacity is no longer guaranteed. Trains with their considerable weights could no longer pass this point. As a countermeasure, a deep strutting or an auxiliary wall could temporarily ensure stability so that the stretch of rails could continue to be used. It is, however, much easier to bond the ballast along the side on which such structural changes are to be made, which would otherwise considerably weaken the ballast track. By simply bonding the ballast bed on a strip beside the track, a stable ballast shoulder can be produced very quickly. This shoulder proves to be advantageous when laying and maintaining control lines and signal lines along the tracks because a trench can readily be dug outside the bonded area and the laid control lines and signal lines can easily be cleared of ballast thanks to the defined stable shoulder of the ballast bed and filled up again after renewal of the lines of the trench without impairing the basic shape of the ballast bed. The ballast bed shoulder, stabilized by bonding, can still be driven on with the usual loads despite the trench excavated directly next to the track. In the case of a professionally bonded ballast track, this can, in a sense, be cut off laterally and, for example, excavation can be carried out directly next to the ballast bed. Thanks to the bonding, the necessary stability of the ballast road is maintained for the usual use by trains, which offers enormous advantages.

However, the discharging of the adhesives for creating such a stable bonding requires that the adhesives are always applied in the correct mixing ratio, that the penetration depth of the mixed adhesive into the ballast bed reaches a precisely specified depth everywhere, and that the quantity of adhesive is also discharged exactly constant at a defined spray width per running meter. Further, such a bonding should not only be possible over a few meters, but over larger sections, quickly and reliably. In doing so, all necessary boundary conditions must be strictly adhered to, such as the temperatures of the adhesive components, an absolutely constant, continuously monitored mixing ratio, a uniform discharging over the section to be treated at a constant speed of the spray jet over the ballast to maintain a constant penetration depth into the ballast bed. Only in this way can it be ensured that the ballast is bonded to a defined depth with a precisely defined amount of adhesive per volume of ballast, depending on the size of the ballast stones and the desired penetration depth. Only if these requirements are strictly adhered to can such a bonding be certified in the sense that a railway train of a certain weight may continue to travel on a rail section where construction measures are carried out laterally as mentioned above, i.e. trenches are dug for line structures or retaining walls or excavations of all kinds.

According to the state of the art, the discharge of such adhesive mixtures has so far not very professional, cumbersome and error-prone, i.e. not evenly, and above all very inefficient. The discharge is carried out manually by means of watering cans or by hand lances, with manually or motor-driven pumps. For example, the two basic components of the adhesive are carried on a railway carriage and mixed on it. The mixture is then filled into watering cans or fed directly to the hand lances via a pipe. To bond one cubic meter of ballast takes 15 liters of adhesive mixture, and when spreading with a watering can, only approx. 4 cubic meters of ballast can be treated per hour. In addition, the spreading quality is highly uneven, as it depends on the skill of the person who casts with the watering can or operates the hand lance and thus walks along the railway track. It is immediately clear that this means that no effectively uniform spray jet with a uniform speed can be passed over the ballast while maintaining a constant distance to the ballast. Accordingly, a bonding produced in this way cannot be certified in the sense that the trafficability of the rail track can be guaranteed and the driving operation continues to enjoy full insurance coverage. This is of great importance for trains with heavy loads of several hundred tons: An accident as a result of a weakened ballast bed with possibly overturning of freight wagons or tank wagons and in the worst case toxic substances flowing into the ground would have enormous consequences for the insurance, which is why a certification of adhesion recognized by the insurance for normal driving on the rail track was not possible so far, but would be of decisive importance.

When the adhesive is discharged manually, the discharge is soon interrupted in order to refill a watering can or to more the supply forward, i.e. the containers and the machinery for pumping the adhesive to the lance in stages, because these containers and equipment are either carried on a railway carriage or transported on the road and set up laterally of the rail section. If for some reason a malfunction occurs, for example a pump runs incorrectly or fails, a single, in itself toxic component can be sprayed in large quantities, which can have fatal consequences for the groundwater. The components may be applied only when thoroughly mixed in the prescribed mixing ratio. Then the mixture hardens reliably and no single component can reach in the earth in isolation.

The bonding must take place quickly and determines the penetration depth as well, because the adhesive runs down through the ballast and by bonding and hardening immediately, the penetration depth is limited. Spreading work usually has to be done outside traffic hours and often at night, and dry weather is also a prerequisite for spreading the adhesive. One recognizes that there are many boundary conditions, resulting in the requirement that a uniform discharge with precisely defined specifications should be carried out by reliably machine and very quickly on site.

If bonding is to take place somewhere at a rail section, for instance in a railway station, or in places that are difficult to access such as bridges, underpasses or overpasses, or in general in places where the stretch of rails is not laterally accessible for vehicles, it is a particular challenge to be able to quickly carry out a uniform discharge there, if possible in one go, i.e. without any interruptions. If one calculates with about 15 liters of adhesive mixture per cubic meter of track ballast to be treated, this is sufficient for 8 running meters of bed to be bonded half a meter deep and half a meter wide beside the rail, and two 200-liter drums are then sufficient for a little more than 200 meter of rail section, and if the bonding is to take place over the full width of the ballast bed, only a section of about 50 meters can be bonded in one pass.

A special challenge for the fast and controlled dispensing of adhesives in perfect mixture and with constant penetration depth over greater distances in one go is the fact that large masses are required for the necessary machinery and the storage containers. For example, powerful pumps are necessary. Further, a self-sufficient power supply is necessary, both for the pumps and for heating the components to be applied, which must be available in large quantities. And then all these devices should be able to be moved along a track. If a railway carriage were to be used for this purpose, which could then be pulled or pushed, it would be far too heavy for transport by road, and the insertion in a rail section would have to be carried out with large crane vehicle. Such a device would be far too cumbersome to be flexible and quick to use. If all devices were to be carried along a rail track by a truck, this would in many places not be able to travel along the rail track, but could be used only in open terrain.

In the state of the art, various devices are known for the controlled mixing of components into a defined mixture, but no devices are known which enable this controlled and precise application of adhesives for bonding ballast beds along railway tracks over many hundreds of meters in one go, and which can be used quickly and flexibly.

It is therefore the task of this invention, given the situation as described above, to create a device by means of which the ballast bed of a section of rail track can be bonded over its entire width or over a selectable part of its width over any distances up to 6 km in one go with a two-component adhesive with a minimum of personnel, namely by only two persons, wherein the device is to be transportable on a single road-transportable vehicle or trailer to the usage site, is to be self-propelled everywhere quickly on the rails of the section to be treated, and with which a two-component adhesive can be applied in selectable spray patterns at a uniform, selectable speed and continuously monitored with definable application rates per time, and thus defined penetration depth, in precisely definable areas into the ballast bed.

The solution of the task is defined by a device having the characteristics of claim 1, as well as by the method according to claim 11 and the use according to claim 15. This device can be transported by road and afterwards by rail to any point on a railway line, in many cases even transported by road precisely to where it is needed. It can be placed on the rail and put into operation within a few minutes and removed from the rail section just as quickly in order to release the passage after the bonding work has been completed. The device enables the controlled application of the adhesive in precisely defined quantities and mixing ratios, with automatic feeding and thus ensuring a defined penetration depth of the adhesive into the ballast bed. The device is self-sufficient as to power and automatically controllable.

First the result of such bonding is shown on the basis of the drawings. Then this device for creating the bonding is presented and described, and its functions are explained. Then the procedure that can be carried out and the use of the device is described and explained in more detail. For this purpose, the drawings show, for example, embodiments of the device, and the task and purpose of the invention are also depicted and explained on the basis of the illustrations.

There are shown

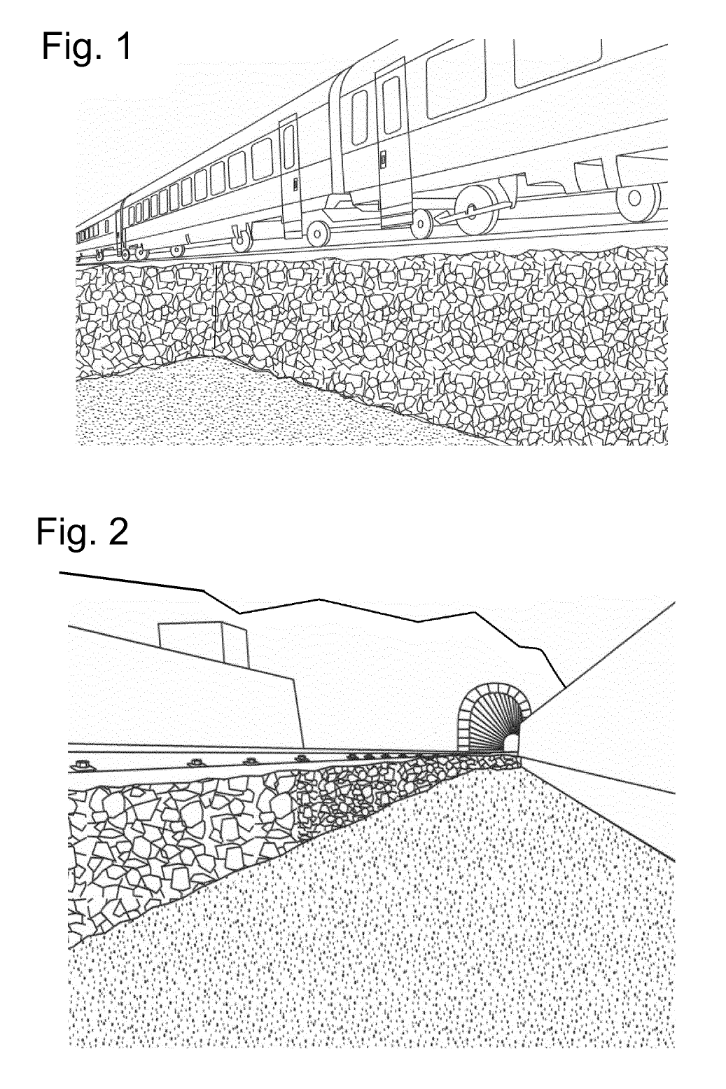

FIG. 1: A cut-off ballast track stabilized by a previous bonding, which a train just passed;

FIG. 2: A cut-off stabilized ballast track along a stretch of rails in front of a tunnel portal;

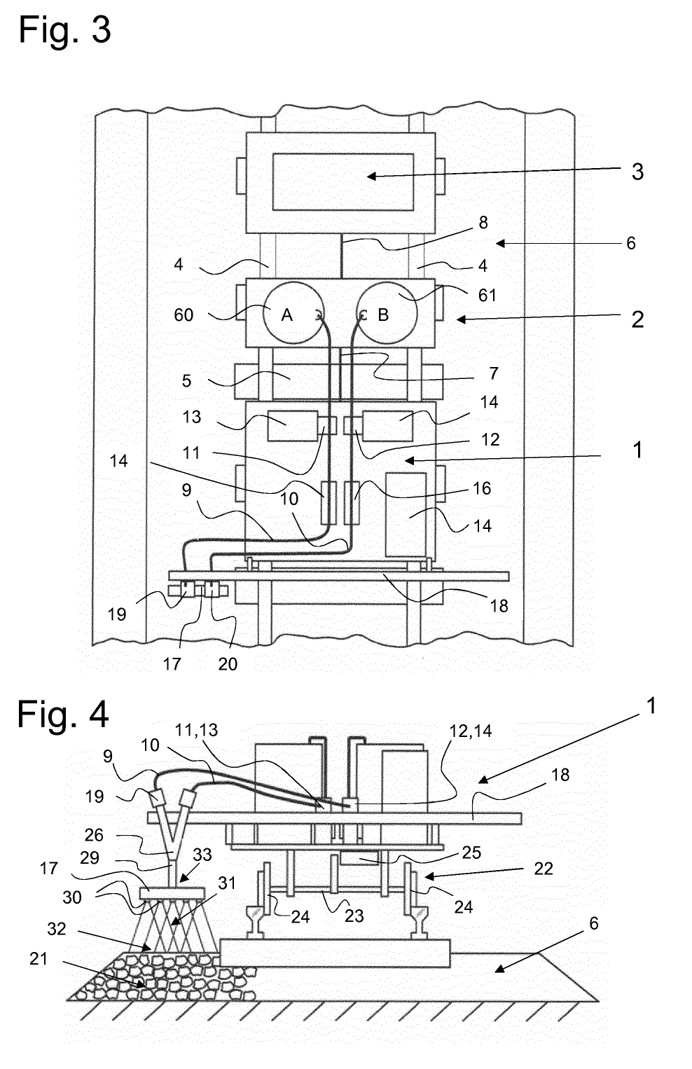

FIG. 3: A device for discharging an adhesive from three cars in a schematic representation from above;

FIG. 4: This device viewed toward its front, i.e. viewed from the front of the spray wagon, represented in a schematic outline;

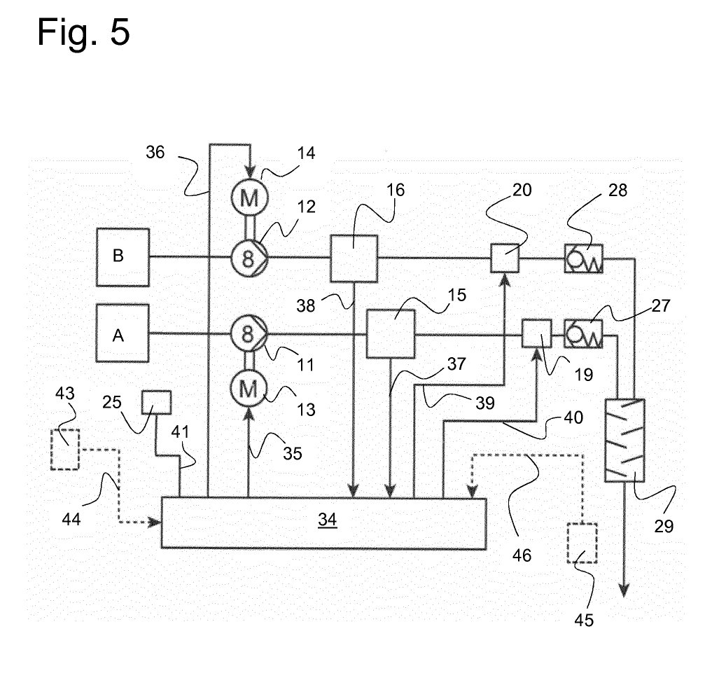

FIG. 5: The block diagram of the means for pumping and mixing the components together on the spray wagon to form a sprayable mixture;

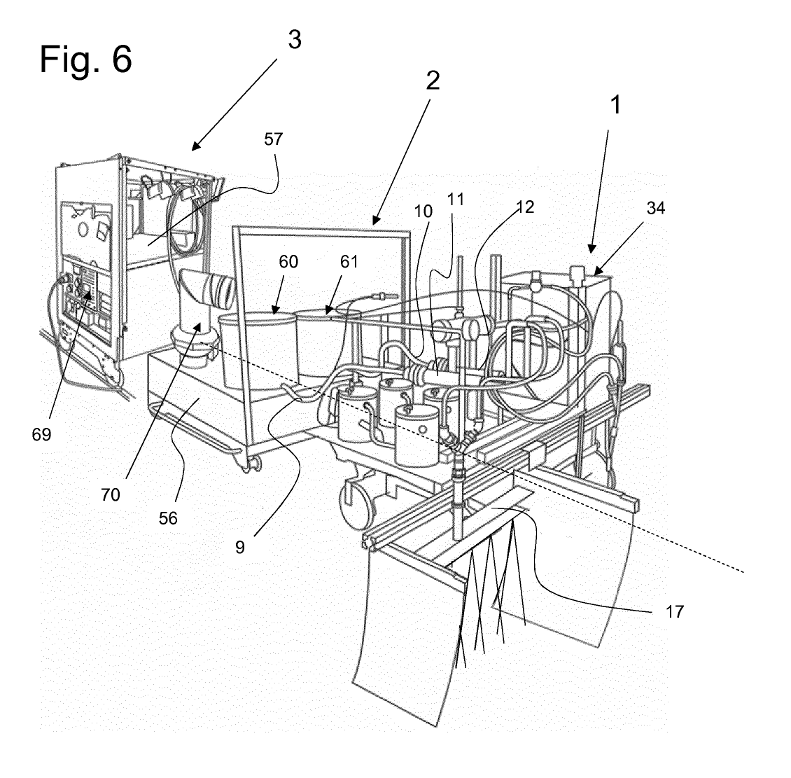

FIG. 6: A device consisting of three wagons, represented in perspective view, with a view of the spray wagon all the was at the front, the container wagon adjacent thereto and the power supply wagon at the rear;

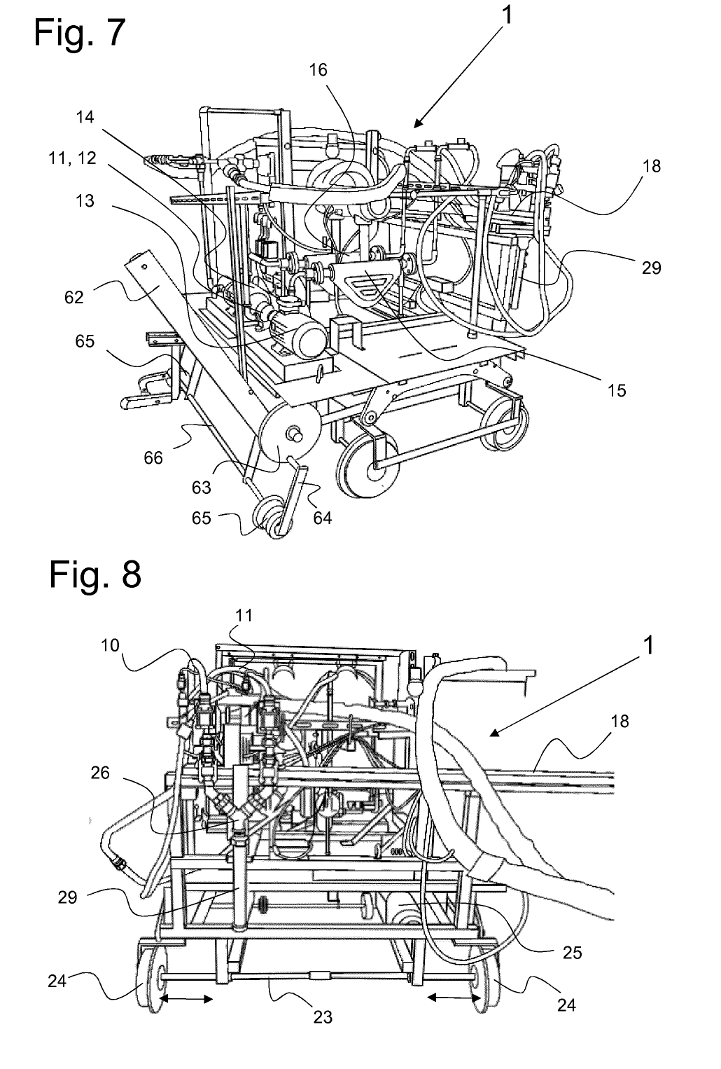

FIG. 7: The spray wagon viewed diagonally from the rear;

FIG. 8: The spray wagon viewed from the front;

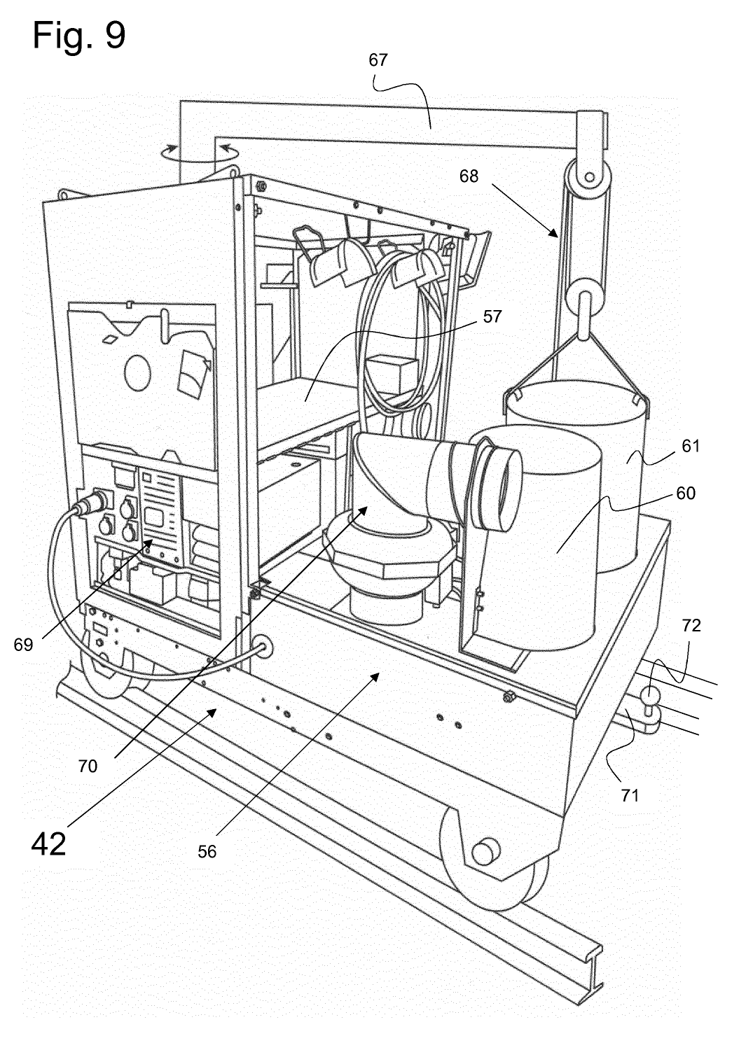

FIG. 9: A combination wagon for the power supply and for carrying the containers for forming a two-part composition together with a spray wagon;

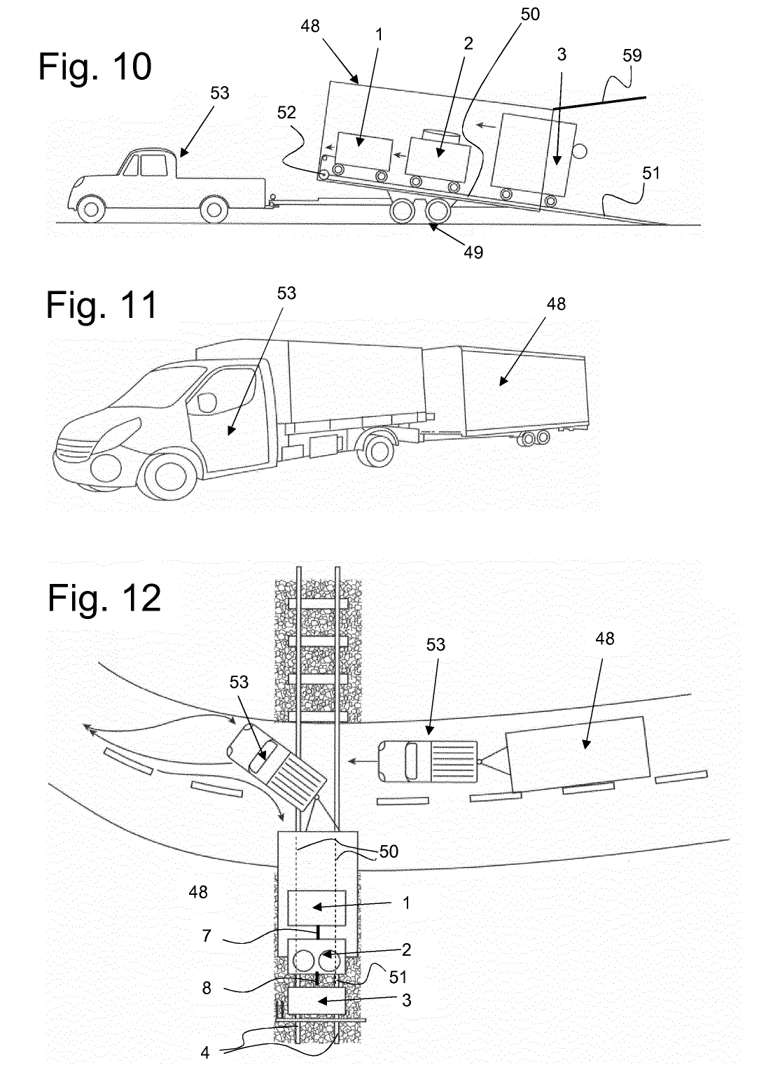

FIG. 10: A device consisting of three wagons when loaded into a trailer;

FIG. 11: A suitable vehicle trailer composition for the transport of entire device and personnel by road;

FIG. 12: A vehicle with trailer and the device therein, consisting of three cars, viewed in a schematic representation from above, upon approaching with the towing vehicle and trailer on a railway line at the place of a level crossing of the road, and afterwards placing the three cars on the rails;

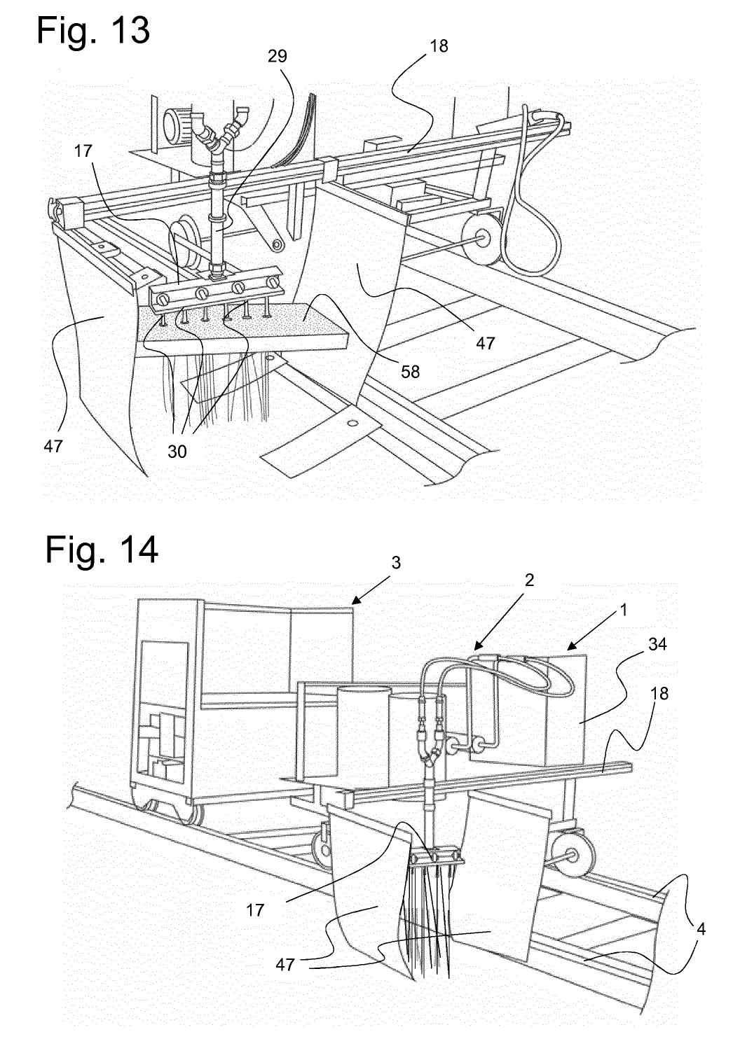

FIG. 13: The front side of the spray wagon with its spray bar when said spray wagon is standing on a stretch of rails and spraying the track;

FIG. 14: A composition of two cars, namely a power supply wagon as well as a spray and container wagon, in use on a stretch of rails;

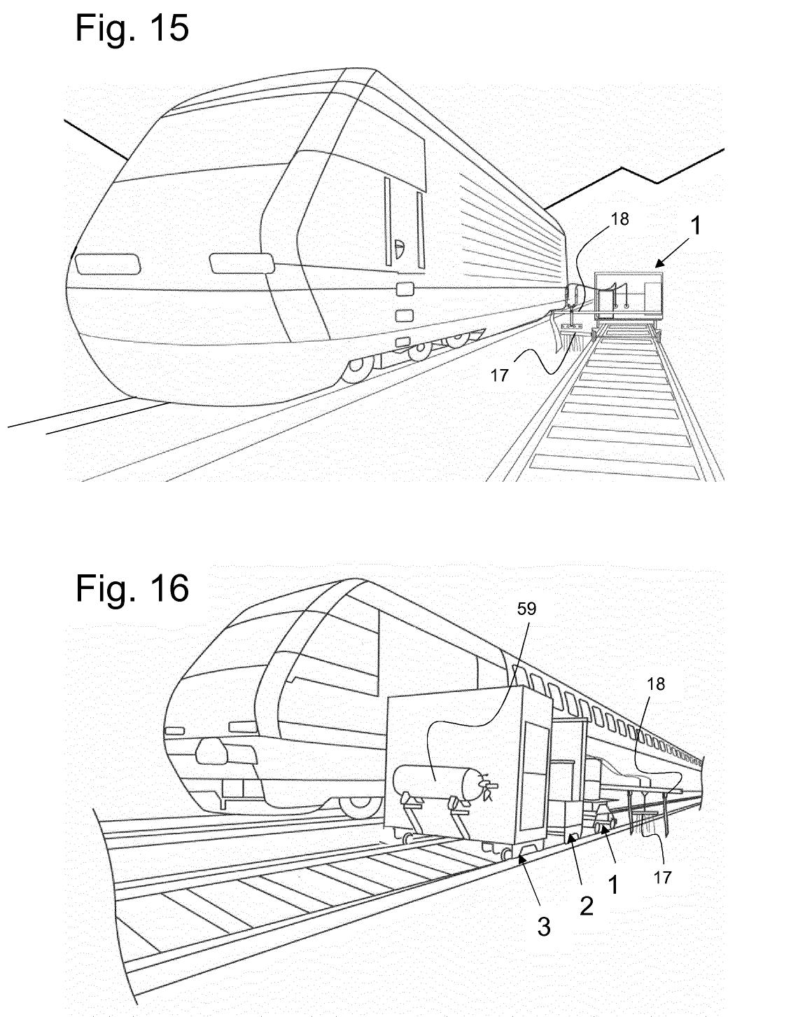

FIG. 15: A view toward the front of the composition at work, and next to it a passing locomotive on the secondary track;

FIG. 16: A perspective view of the composition diagonally from the rear, with the train passing on the secondary track;

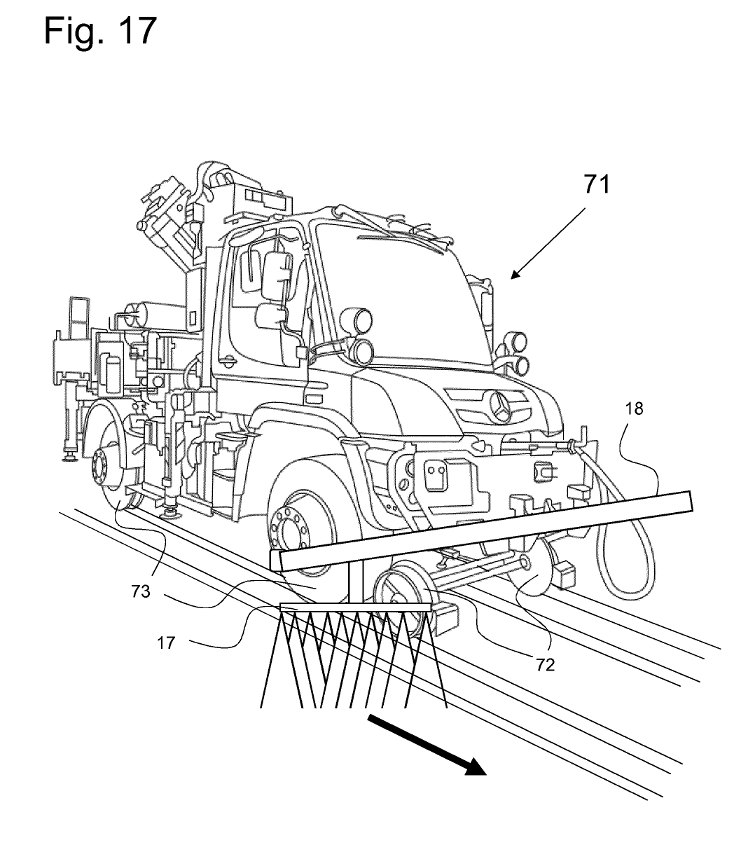

FIG. 17: A rail-compatible road vehicle having all elements for electric power supply and control for the pumping by means of gear pumps, for the mixing and controlled discharging of the components of a multi-component adhesive via the spray bar mounted at the front.

FIG. 1 shows an application, namely a ballast track cut off longitudinally just outside a stretch of rails, which was previously bonded by spraying on a two-component epoxy resin, so that it forms a quasi-monolithic block. In this state, the ballast road can be cut off by an excavator shovel, as shown here, but it remains stable, so that vertical walls can be cleared of ballast without the ballast track losing much of its load-bearing strength and stability. Whenever, for example, cables or pipes have to be laid along such a stretch of rails, there are major challenges for maintaining the stability of the rail track if trains are to continue to run on it, i.e. during the installation work for the lines and pipes. Without the possibility of route stabilization, the stretch of rails would have to be closed for railway traffic, which would mean major restrictions and expensive downtimes for the railway operators.

FIG. 2 shows another ballast track stabilized by bonding and then cut off along a stretch of rails in front of a tunnel portal. As one can see, a trench often has to be dug over considerable distances, and here the problem now arises in particular how to stabilize a ballast track over greater distances so reliably and safely that the track that is later cut off can be certified for trains with normal load. If discharged by hand, no one can guarantee the homogeneity of the bonding. In addition, bonding by hand is much too slow, labor-intensive, inaccurate and correspondingly expensive. This is where this invention comes in and makes it possible to bond ballast tracks on a completely different scale, much faster and more efficiently, completely homogeneously, with precisely constant, selectable bonding width and with precisely definable penetration depth of the adhesive over the entire bonding process. Only such a mechanical discharging of the adhesive can be so precise that the bonding and stabilization can be certified, so that a railway operator can be sure that even fully loaded trains can drive on this bonded track without hesitation and may do so from an insurance point of view.

FIG. 3 shows for this purpose, for example, a device for applying the adhesive, consisting of three cars, in a schematic representation from above. The decisive solution for the realization of a road-transportable device, which can be operated by just two persons, is that the device is either built directly onto a rail-compatible road vehicle that can be driven directly onto a stretch of rails on site and driven thereon, or else that it is functionally divided into at least two or three units or two or three separate wagons, which can be loaded and unloaded separately onto a road vehicle or a road trailer and can therefore also be placed separately or individually onto the rails of a rail line by only two persons. A single wagon weighs approx. 350 kg, and only the wagon with the component containers, empty approx. 250 kg, is heavier, up to 2000 kg, depending on the load. However, if the device were built as a one-piece machine, it would work, but its handling and transport would become much more complicated. It could hardly be loaded onto a vehicle and mounted on a rail track by a small number of personnel and without a crane. Furthermore, it would be technically very demanding to bring such a heavy device to the site of operation and place it on the rails there.

And thus FIG. 3 shows a device according to the invention on rail wagons, which are placed on rail tracks 4, schematically represented from above, in plan view. Here the railway rails 4 are standing on the crossbeams 5, which are embedded in the ballast track 6. The composition of rail wagons here consists of three units that can be coupled together and easily separated again. The front unit is a spray wagon 1 with four rail wheels, followed by a first trailer as container wagon 2, also with four rail wheels, and a second trailer coupled to the rear with four rail wheels as power supply wagon 3. These trailers 2, 3 are coupled together via detachable drawbars 7, 8. For this purpose the wagons are equipped with spherical trailer hooks. For example, the drawbars can each be made of two conventional car trailer drawbars, so that you get a drawbar 7, 8 in the form of a single rod about half a meter long, which has a coupling socket at both ends. On spray wagon 1, one can see the two supply lines 9, 10 for the two components of the epoxy resin mixture. They lead through two gear pumps 11, 12, each precisely controllable by an electric motor 13, 14. From gear pumps 11, 12, the supply lines 9, 10 each lead through a mass flow meter 15, 16 and finally to the spray bar 17, where they lead via a Y-shaped connection to one or more spray nozzles. The spray bar 17 can be moved over a horizontal cantilever 18, which extends across more than the width of the spray wagon, allowing spraying to the right or left of the wagon or in any position therebetween. The spray bar 17 can be swiveled around its vertical axis to vary the spray width as required. Pneumatic valves 19, 20 are installed in front of the spray nozzles in order to stop the flow sharply or instantly if necessary. Drawn by the coupling rod 7, container wagon 2 follows behind spray wagon 1, which here carries two 200-liter drums 60, 61 for the two components A and B of the epoxy resin adhesive. The rearmost wagon, namely the power supply wagon 3, is pulled via another coupling rod 8.

The self-propelled unit, i.e. the sprayer 1, is represented in FIG. 4 as viewed from the front. Below the rails 4 one can see the ballast bed 6, which consists of a granular mixture of a multitude of ballast stones 21, wherein in FIG. 4 such ballast stones 21 are indicated only on one side. The spray wagon 1 contains a chassis 22 having two axles 23 and four wheels 24. The wheels 24 on both sides of the wagon are movable on their axles 23 along the axles and are provided with a mechanical coupling so that they traverse symmetrically outwards or inwards. This means that the wheels 24 of all wagons 1, 2, 3 are part of a track change system, whereby the wagons 1, 2, 3 can be used on tracks of the largest track widths down to the narrowest track widths. The wheels on at least one of axles 23 can be driven by an electric 24V drive motor 25. To control the flow rate of the first component A, a first gear pump 11 with an associated speed-regulated electric drive 13 is arranged on the self-propelled sprayer wagon 1. A section of a first supply line 9 leads from this first gear pump 11 to a first mass flow meter (not represented here), which serves for measuring the flow rate. A further section of the first supply line 9 leads from the mass flow meter to a first controllable pneumatic valve 19 and then to a first non-return valve and flows via a Y-fitting 26 into a mixer unit 29. Parallel to this, an identical second gear pump 12 is arranged for the second component B with an associated speed-regulated electric drive 14. From the second gear pump 12, a section of a second supply line 10 leads to a second mass flow meter (not represented here), and then to a second controllable pneumatic valve 20 and then to a second non-return valve up to the mixer unit 29. The mixer unit 29 contains a static mixer inside, for example in the form of a grid-shaped structure or a spiral mixer approx. 10 cm long, and is attached to a cantilever 18. An average inner diameter of the supply lines 9, 10 measures 1.5 cm, for example. A discharge device in the form of a spray bar 17 is mounted on the fluidic outlet side 33 of the mixer unit 29. The spray bar 17 consists of a horizontal hollow cylindrical profile having, for example, five interchangeable flat-spray nozzles 30 arranged next to each other at regular intervals of 5 cm, each with a nozzle diameter of e.g. 1 mm. Each of the flat-spray nozzles 30 can generate a fan-shaped jet 31. The flat-spray nozzles 30 are arranged next to each other in such a way that the jets 31 that can be produced with it form a continuous flat or curtain-like overall jet in an area to be sprayed 32 on the ballast bed 6. For example, a spray width of the total jet in the application area 32 on the ballast bed 6 is approx. 55 cm. The distance between the flat-spray nozzles 30 and the ballast bed is approx. 40 cm.

FIG. 5 shows a block diagram with all means for pumping and mixing the components together to form a sprayable mixture on the spray wagon. The two electric drives 13, 14 of the two gear pumps 11, 12 can be controlled independently of each other via each a control line 35, 36 by the control unit 34 by outputting two independent output signals. Thereby the flow rates of the two gear pumps 11, 12, and thus the flow rates in the two supply lines 9, 10, can be controlled independently of each other. Via the signal lines 37, 38 between the two mass flow meters 15, 16 and the control unit 34, the flow rates in the two feed lines 9, 10 can be independently detected, controlled and processed in the control unit 34.

Further signal lines 39, 40 between the control unit 34 and the two pneumatic valves 19, 20 allow these to be opened and closed. The pneumatic valves 19, 20 are each followed by a non-return valve 27, 28. Between the control unit 34 and the 24V drive motor 25 there exists another signal line 41, which enables controlling the speed of spraying wagon 1. The control unit 34 has a microprocessor control having a memory and a processing unit. The mixing ratios to be maintained between components A and B, the desired flow rates or total flow rates and the speed of spray wagon 1 can be entered and stored as set values in the memory via the control unit or an input interface. The processing unit is programmed to run a control program that ensures that the mixing ratios between components A and B and the flow rates are exactly maintained down to a few percent. In the event of major deviations, the discharge of components A and B is automatically stopped.

Thus, for example, one pressure relief valve each can be integrated in the supply lines 9, 10 between the two gear pumps 11, 12 and the outlet of the pressure relief valves can be equipped with return lines which can be used to return a fluidic component A or B that exits upon an open pressure relief valve to an associated section of the supply line upstream of the associated gear pump 11 or gear pump 12. In principle, the mass flow meters 15, 16 can also be omitted and instead additional position sensors can be provided on the gear pumps 11, 12 and/or the associated drives 13, 14.

As shown further in the block diagram in FIG. 5, a speed sensor 43 can be provided, which transmits information about the current travel speed of the spray wagon 1 to the control unit 34 via an associated signal line 44. This makes it possible to precisely control the throughput of the two fluidic components as a function of the current speed of spray wagon 1. Furthermore, the discharge device or the spray bar 17 can be arranged movable along the cantilever 18. For example a rack-and-pinion drive can be used for this purpose. The width of the sprayable area 32 are greatly increased by the movability. The controlling of the movement of the spray bar 17 of the discharge device can in turn be controlled by the control unit 34 and synchronized, for example, with the speed of the spray wagon 1 and the flow rates. It is also possible to provide a sensor 45, indicated in the block diagram in FIG. 5, with which the condition of the area to be sprayed can be continuously checked and transmitted to the control unit 34 via the signal line 46. For this purpose, for example, ultrasonic sensors and/or laser-based sensors can be used. This allows areas not to be sprayed, such as sleepers 5 or rails 4, to be automatically detected and the discharging can be interrupted when passing over these areas. On the one hand, this saves adhesive and, on the other hand, reduces the effort because these areas do not have to be covered beforehand. Furthermore, additional covers can be attached to the spray wagon 1, which, for example, prevent the rails 4 from being coated with adhesive during discharging. All in all, the spreading of the two mixed components A, B can be effected fully automatically by controlling everything from the programmable control unit 34. It ensures that the entire device with its wagon composition is carried out at a uniform speed and uniform discharge of the adhesive over a precisely specified width and in such a quantity that exactly the right penetration depth is maintained. It can also be programmed so that the penetration depth varies over a certain distance, i.e. becomes steadily deeper, or becomes steadily shallower as of a certain depth.

In FIG. 6 the furnishings as a composition of three cars is represented, with the spray wagon 1, which weighs approximately 350 kg, right at the front. On the first trailer, the container wagon 2, which is coupled directly to the self-propelled spray wagon 1, there is a first drum-shaped container 60 with a liquid polyurethane resin and a second drum-shaped container 61 with a liquid hardener. The liquids in the two containers 60, 61 are components A, B of a two-component polyurethane adhesive. This container wagon weighs approx. 250 kg, and up to 2.000 kg when fully loaded, depending on the capacity of the loaded containers. From these drums or containers 60, 61, the supply lines for the adhesive components A, B lead to the spray wagon 1 and finally, after being mixed together by combining in a mixer, for example a spiral mixer, to the spray nozzles on the spray bar 17. The viscosities of the two liquid components are in the range of approx. 200 mPas. The two containers 60, 61, for example, have a capacity of 200 liters each, though larger or smaller containers can also be used. As a special feature, these containers 60, 61 can be adjusted in recesses in the top of an otherwise hollow box, wherein the inside of the box acts as a catch basin 56 in case of leakage and can be heated as well as ventilated in order to always keep components A, B at their ideal temperature. The heating can be a temperature-controlled electric or a gas heating, with propane gas, as is usual on camping sites. The container trough 56 is also equipped with a ventilation system, from which one can see the vent pipe 70, which is also used for temperature control of the components if they become warm in summer. A further section of the first supply line 9 connects the first container 60 with the first gear pump 11, and a further section of the second supply line 10 connects the second container 61 with the second gear pump 12.

In the second trailer, the power supply wagon 3, weighing in the order of 350 kg, there is a diesel engine and switchable power-generating diesel generator with 400V output voltage, as well as a compressed air generation system with compressed air tank, whose compressor can also be driven by the diesel engine, and further aids for operating the device. Power and compressed air are conducted from this power supply wagon 3 via lines (not shown) to the front via container wagon 2 to spray wagon 1. Electric power is required, among other things, to drive the cars by means of 24V traction motors. The secondary drives for the wagon wheels can be chain drives or toothed belts, for example. The gear pumps on the sprayer are also driven by electric motors and, alternatively, the heating on container wagon 2 can also be electric. Furthermore, the control unit 34, which is located either on the power supply wagon 3 or on the spray wagon 1, requires electric power. This control unit 34 processes the signals from the mass flow meters and all other sensors, for instance from those for measuring the travel speed and from the thermometer on the container wagon 2. It generates control signals for the gear pumps, for the pneumatic safety valves at the spray nozzles and for the drive motors for driving as well as for heating and cooling the components A, B. Compressed air is required for the pneumatic safety valves as well as for any compressed air tools on the power supply wagon 3. It can be designed as a workplace, with a work surface 57 like a workbench, and with all kinds of tools for any possible service and repair work that might be necessary. In FIG. 6 one recognizes only the control panel 69 for operating the diesel engine. and generator as well as the compressor for generating compressed air. A control unit 34 with an operating unit, a display unit, a microprocessor control and several input and output interfaces is located on spray wagon 1. However, the control and power lines between the various components are not explicitly represents in FIG. 6, but are derived from the block diagram described in FIG. 5.

FIG. 7 shows a spray wagon 1 viewed diagonally from the rear. Here, one can clearly see the two electric motors 13, 14 for gear pumps 11, 12 for precisely metered delivery of the two adhesive components A, B, and one can also see the two mass flow meters 15, 16. The lever 62 at the rear of the wagon is used to lift the spray wagon 1 so that it can be hoisted from level ground onto a rail lying on this ground. If the lever 62 is swiveled down by hand, it turns the swivel wheel 66 and the load lever 64 in the same direction. This causes the undercarriage of spraying wagon 1 to lift off at the rear at the two support wheels 65, which are connected to a connecting axle 66. At the front of the wagon one can recognize the cantilever 18 with the mixer, for example a spiral mixer 29, which can be moved back and forth on said cantilever.

In FIG. 8 the spray wagon 1 is represented from the front, and here one can see the cantilever 18 as well as the spray unit which can be moved back and forth on said cantilever, with which the two supply lines 10, 11 are brought together via a Y-fitting 26 and the components A, B are pumped into a mixer, here into a spiral mixer 29. At the bottom, the spiral mixer 29 opens into the spray bar, which is not drawn it.

Instead of dividing the device into three separate carriages as just presented, a version with only two carriages can also be implemented. In this case, for example, container wagon 2 and power supply wagon 3 are combined into a single trolley 42, as is represented in FIG. 9. Together with a separate spray wagon 1, this composition also forms a suitable device, if both wagons 1, 42 are of approximately equal weight, approx. 500 kg. The handling of this device and its two carriages 1, 42 can be done by two people. This makes the furnishing even more compact and the furnishing is even faster, because only two cars instead of three have to be coupled together on site. At the front of this wagon 42 one can see the trailer hitch 71 with a coupling ball 72 for this coupling. The ball socket of a drawbar can be coupled to this ball 72, whereby the drawbar also has a ball socket at its other end, for coupling this to the next trolley, for example a container wagon or spray wagon. The wagon is equipped with a crane 67 having a pulley 68 or an electric drive, so that the containers 60, 61 can easily be hoisted from a vehicle into the catch basin 56 and used there.

Otherwise, the composition can also be divided such that the spray wagon 1 simultaneously holds the containers for the two components A, B and the second wagon serves solely as a power supply, i.e. for generating power, and generating and supplying compressed air as well as a workshop wagon with its work surface 57.

The division into either two 1, 42 or three carriages 1, 2 and 3 is the key for the flexibility of the device, so that it can be brought to the site by a road vehicle. Thanks to the division into two or three cars of approximately the same weight, the total weight of the device can in any case be handled by just two people. Thereby the device can even be transported on 3.5-ton vehicles on the road and at the usage site be put on the rails of a railway stretch of rails and put into operation, again by just two people.

For very long stretches to be bonded, a large tank wagon in the form of a freight wagon having a plurality of large containers placed on it can be pulled as the rearmost wagon. From this railway carriage, supply lines then lead into the container wagon and its containers 60, 61, which then serve as buffers, to preheat the components to the ideal temperature. For such applications it is advantageous if all two or three cars of the device are executed as self-propelled cars, i.e. their wheels can each be driven by electric motors. It is advantageous to synchronize the speed between the various self-propelled wagons with the speed of the shunting locomotive. The power for this is provided by the 400V generator on the power supply wagon 3. For a very large number of adhesive components carried on a long freight wagon, the device may have to be pushed by a separate shunting locomotive. The described speed sensor 43 ensures that the throughput of the two fluidic components is precisely controlled in dependence on the current speed of the vehicle. Changes in the speed of any additional shunting locomotive can thereby be compensated for. The spray wagon with its pumps allows approx. 21 cubic meters of track ballast to be bonded per hour. If, for example, 6,000 liters of adhesive mixture are transported on the container wagon or on the railway wagon, the machine can work for 19 hours in a row and bond 400 cubic meters of track ballast perfectly and evenly.

On the basis of FIG. 10 it is explained how the loading of a road vehicle with the device, here three cars, is done. Advantageously, a road trailer 48 is used for motorcar transports. FIG. 10 shows one such an enclosed road trailer 48 having a tandem axle 49, here with opened tailgate 59. It is equipped with rails 50 inside, of which one part 51 can be pulled out toward the rear, or which have a swing-out section 51 at the rear. The rails 51 can therefore be positioned beyond the rear edge of the road trailer 48 and the road trailer 48 can be tilted backwards, so that one wagon 1, 2, 3 after the other can be driven from a flat concrete surface onto the rails 50, 51 in the road trailer 48 and can afterwards be pulled into the road trailer 48. An electric cable winch 52 on the front of the trailer 48, as it is normally used to load a wagon, is the best way to do this. As was shown in FIG. 10, first the spray wagon 1 was pulled into the road trailer 48, then the container wagon 2 and finally the power supply wagon 3. Thereby the wagons 1, 2, 3 are also loaded in the correct sequence as they are needed at the usage site. After loading, the rails 51 are stowed away in the road trailer and this can be swiveled into the horizontal position. Subsequently the road trailer 48 can be moved by a towing vehicle 53 to any location. A 3.5-ton road vehicle can be used for this purpose. This has the advantage that it can be driven with a car driving license and is not subject to any blocking periods, such as bans on night driving or Sunday driving, and is also not subject to the heavy-traffic tax, as is the case with trucks in many places. All this offers enormous flexibility and operational readiness at any time of the day or night, and the simple handling of the entire device can be mastered by just two people. It is no longer necessary to have a large work force.

FIG. 11 shows an ideal composition of a 3.5-ton road vehicle 53 and an associated road trailer 48 as it is suitable for transporting the entire device on the road. The road trailer 48 can accommodate the entire device, whether consisting of two or three separate rail wagons, and the road vehicle has 2 to 3 seats, which is enough for a whole team of workers, because no more than two people are needed to unload the device on site and to place it on the railway tracks and afterwards operate it. Because a road vehicle of the category up to 3.5 tons total weight can be used, there are no restrictions in traffic, for example in comparison to a truck of 7.5 tons or more total weight. There are neither driver's log requirements nor restrictions due to the weight or width of the road vehicle. For 3.5 tons vehicles there are no night-driving bans and they can be driven by almost anyone. A spraying team is therefore not dependent on a person having a truck driver's license. Instead of a towing vehicle, in individual cases a self-propelled low-bed vehicle transporter can also be used, onto which the wagons 1-3 can be loaded.

FIG. 12 shows in a schematic representation from above of how the device is placed on the rails 4 at a usage site. Level crossings or wherever the upper side of the rails run flat to a concrete slab or asphalt pavement or a wooden base prove to be the ideal place to place the device on the rails 4 of a railway stretch of rails. Here the situation at a level crossing is shown. Here, the road vehicle 53 with its road trailer 48 and the device therein comes from the right, then drives over the level crossing as drawn with the arrow, and subsequently maneuvers the trailer 48 backwards into the drawn position. The road trailer 48 is then tilted backwards, as already shown for loading rail cars 1, 2, 3. The three rail wagons 1, 2, 3 are visibly indicated here on trailer 48. Now the rails 51 in the road trailer are extended backwards or swiveled out so that they extend the inner rails 50 in exactly the same direction with their ends precisely positioned on the railway rails 4. Afterwards the cable winch belonging to road trailer 48 is used to let the power supply wagon 3 from the road trailer move slowly backwards on rails 50, 51 until it touches down on the railway rails 4. The same is then done with container wagon 2 and finally with spray wagon 1. Each single wagon 1, 2, 3 is just so heavy that it can easily be carried out by two people. One person operates the winch, the other monitors the moving out and can intervene if necessary. As soon as all cars 1, 2, 3 are on track 4, they are coupled together with the coupling rods 7, 8 in the form of double drawbars in all directions. Thereafter the device is in the picture ready to be driven up the road and afterwards spray the ballast bed on the desired side.

In FIG. 13 one recognizes the front of spray wagon 1 in use. At the front of spray wagon 1, one can see the cantilever 18 and the spray bar 17 hanging from it, as well as on both sides thereof a cover 47 in the form of a plastic mat, which precisely limits the spraying on the sides. The spray bar 17 is equipped with a number of nozzles 30, so that different spray patterns of the adhesive mixture can be sprayed. In the picture shown, the spray jets are sprayed through a filter 58, which, however, is not always necessary. The spray bar 17 can be moved horizontally along the cantilever and also vertically by motor control.

In FIG. 14 a composition of two rail cars is represented, namely a one-piece spray wagon 1 and container wagon 2 as well as the power supply wagon 3. A look at the front of the spraying wagon 1 currently being used shows how the spray bar with its nozzles 30 sprays the adhesive mixture onto the ballast bed below. It is possible to exactly determine how many grams of adhesive are applied per running meter at a certain spray width and travel speed, and it is also possible to determine which spray pattern is best suited, here for instance a flat spray curtain or a spray cone, depending on the conditions. To the left and right of the spray bar 17, covers 47 in the form of rubber flaps are mounted, so that the spray area is safely limited on the sides. The control unit 34 of the device ensures that the selected values are constantly and reliably maintained. If any fault occurs in the supply of components A, B, this is registered by means of the flow meter signals and spraying is stopped immediately by closing the pneumatic valves on the spray nozzles 30. Thereby it is ensured that no single component that is otherwise highly toxic ever gets into the ground. The spray bar 17 is mounted on the cantilever 18 so that it can swivel about its vertical axis and runs at an oblique angle to track 4, but can also be adjusted perpendicular to this. Its height above the ballast bed can also be varied, and it is clear that the spray bar 17 can be moved anywhere on the cantilever 18, depending on where the spray strip is to be put. For the width shown here outside the one rail of the stretch of rails, in most cases approx. 15 liters of adhesive mixture per cubic meter of ballast track to be bonded are expected. Of course, the spread rate per area or cubature can be freely varied according to experience and the desired penetration depth of the adhesive into the ballast bed.

In FIG. 15, one looks at the front of spraying wagon 1, which here sprays adhesive on the left side of the stretch of rails on which the device is standing. The adjustable and continuously checked driving speed of the two or three wagons of the device guarantees an exactly even spreading of the adhesive. Throughout the entire operation, train traffic can continue on an adjacent track, as shown in FIG. 15, where a locomotive is passing the device.

FIG. 16 shows the device in a perspective view with a view of the composition diagonally from the rear, with a train passing by. A compressed air tank 59 is mounted at the very back of the power supply wagon 3. This is supplied by the on-board diesel engine and compressor with compressed air and ensures an adequate supply of compressed air for the tools to be operated and for the pneumatic safety valves at the spray nozzles. Of course, the compressed air tank can also be accommodated inside the power supply wagon 3.

When applying the two-component adhesive with the device according to the invention, made it possible to produce high-quality bonding of well-defined width and depth. Investigations of rigified or bonded track ballast according to the invention have shown that these contain hardly any defects and hold much better than conventionally treated track ballast. This even resulted in this spreading method having been certified by the Swiss Federal Railways and is therefore also recognized by insurance companies, i.e. if it is used properly, tracks having been bonded by said method can be used normally, even if they are cut off on the side and without bonding would never be stable enough for trains to travel on them.

FIG. 17 finally shows a rail-compatible road vehicle 71, on which all elements for the electric power supply and control for the pumping by means of gear pumps, for the mixing and controlled discharging of the components of a multi-component adhesive via a spray bar 17 mounted at the front are present. All elements, components, parts, etc. described above are combined on this vehicle 71, including the diesel generator for the power generation, the compressor with pressure tank for a supply of approx. 30 liters of compressed air for the operation of the compressed air tools carried along as well as the pneumatic safety valves at the spray nozzles. A heating device for preheating the components to the ideal temperature is also included. With this vehicle 71 you can drive directly onto a railway line at any location. Then the rail wheels 72 are lowered and locked hydraulically, after which the vehicle 71 with its tire wheels 73 runs on the rails and is guided on them by the rail wheels 72. On site, the cantilever 18 is mounted to the front of vehicle 71, the spray bar 17 mounted to said cantilever and the flexible hoses are connected. Everything else works essentially the same way for a two-part or a three-part composition as described in detail above. The components A, B can be carried along directly on this vehicle 71 or else larger quantities of adhesive components can be carried in separate containers, for example on a railway freight wagon, by attaching this railway freight wagon to the rail-compatible road vehicle 71 and pumping the components out of these containers on this railway freight wagon using the flexible hoses and spraying them after mixing. Thereby the capacity can be greatly expanded. Distances of many kilometers can be treated very quickly by only two people as operators, wherein it is ensured, however, that the spreading is carried out in perfect mixture and perfect uniformity. If, for example, 6.000 liters of adhesive are carried on a rail wagon, 400 cubic meters of track ballast can be bonded in one work process, which can be done in less than 20 hours. Today, with the usual manual spreading alone, such a quantity requires at least 100 hours on site, i.e. in reality approx. 2 working weeks, without counting the carrying and transport of comparatively small batches of components. And yet there is no guarantee that the bonding is so evenly done that the track can subsequently be certified for driving on and that there is no risk of the track collapsing under heavy loads.

In summary, this device for discharging a multi-component adhesive has enormous advantages over the conventional manual application, especially when bonding or consolidating ballast in railway installations. In particular, it can be used in a highly flexible manner by being easy to transport on the road, where it can be placed on the rail by just two people, and afterwards it makes it possible to massively increase the speed at which the multi-component adhesive is applied and to greatly improve the quality of the bonding of rail track ballast.

### LIST OF NUMERALS

1 Spray wagon
2 Container wagon
3 Power supply wagon
4 Railway tracks, track
5 Railway sleepers
6 Ballast bed
7 Drawbar coupling between 1 and 2
8 Drawbar coupling between 2 and 3
9 First supply line for component A
10 Second supply line for component B
11 First gear pump for component A
12 Second gear pump for component B
13 Electric motor, drive for 11
14 Electric motor, drive for 12
15 Mass flow meter for component A
16 Mass flow meter for component B
17 Spray bar
18 Cantilever for spray bar
19 Pneumatic safety valve for component A
20 Pneumatic safety valve for component B
21 Stones of the ballast bed
22 Chassis
23 Axle of the chassis
24 Wheel of the chassis
25 24V drive motor
26 Y-shaped fitting
27 Non-return valve for component A
28 Non-return valve for component B
29 Spiral mixer
30 Spray nozzles
31 Spray pattern
32 Spray area
33 Fluid outlet side
34 Control unit
35 Control line for electric motor 13
36 Control line for electric motor 14
37 Signal line from mass flow meter for component A
38 Signal line from mass flow meter for component B
39 Signal line from control unit 34 to pneumatic valve 19
40 Signal line from control unit 34 to pneumatic valve 20
41 Control line for traction motor 42
42 Only one wagon for containers and power supply
43 Travel speed sensor
44 Single line travel speed sensor to control unit
45 Sensor for the consistency of the area to be sprayed
46 Signal line from sensor 45 to control unit 34
47 Covers on the left and right side of the spray bar in the form of rubber mats
48 Trailer
49 Tandem axle
50 Rails inside the trailer
51 extendable or swing-out rails on the trailer
52 Cable winch on the trailer
53 Towing vehicle
54 Container on the freight wagon
55 Shunting locomotive
56 Catch basins
57 Work space, workbench
58 Sieve for the adhesive mixture
59 Compressed air tank
60 First container for component A
61 Second container for component B
62 Power lever for lifting the spraying wagon
63 Turning wheel for the power lever 62
64 Load lever for lifting the spraying wagon
65 Support wheel for lifting the spraying wagon
66 Connecting axle between the two support wheels 65
67 Crane cantilever
68 Pulley block
69 Control panel for generator, diesel engine
70 Ventilation pipe for fan to catch basin
71 Railway-compatible road vehicle
72 Rail wheels
73 Tire wheels

1-15. (canceled)

16. An apparatus for transporting multi-component adhesives of at least two fluidic components for spreading the at least two fluidic components from separately stored components to a granular ballast bed of a railway track at a site of use, and for carrying along and discharging said multi-component adhesives at the site of use onto the granular ballast bed of the railway stretch of rails, said apparatus for transporting multi-component adhesives being road transportable and rail-suitable by comprising either a rail-suitable road vehicle or at least one road-transportable rail vehicle with a road vehicle or road trailer belonging to the device for transport by road, with gauge-changeable rail wheels, and wherein said road or rail vehicle comprises provides for the electric power supply and control for pumping the components via gear pumps, for their mixing and for their controlled discharge as multi-component adhesive via a spray unit belonging to the apparatus, which includes a spray bar and is mounted on one of said vehicles for serving as a spray wagon, said components being pumpable from at least two separate containers which are able to be carried in catch bins on said rail-suitable road vehicle or on one of said road-transportable rail vehicle of the apparatus, wherein the components are able to be pumped via flexible hose lines, each by a gear pump and a mass flow meter to a mixer and then to said spray bar, and wherein said spray bar is horizontally and vertically movable in an automatically controlled motor-driven manner at said spray wagon and being mounted rotatable in all directions on a cantilever extending across a width of the vehicle of said spraying wagon, for the speed-dependent controlled spreading of the adhesive mixture in a plurality of selectable spray patterns.

17. The apparatus for transporting multi-component adhesives of at least two fluidic components for spreading the at least two fluidic components from separately stored components to a granular ballast bed of a railway track at a site of use according to claim 16, further comprising at least two separate wagons drivable on rails with gauge-changeable rail wheels, said wagons being road-transportable in their entirety in a single road vehicle or road trailer, and able to be coupled using a drawbar in a tension-locking manner and connectable to hoses and cables, wherein a first wagon of said at least two separate wagons is a spray wagon and includes pumping means, mixing means and controlled discharging means of said components via flexible hose lines belonging to the spray unit, and the second wagon of said at least two separate wagons is a tank wagon having catch basins for inserting and heating the separate containers with the fluidic components to be used and mixed.

18. The apparatus for transporting multi-component adhesives of at least two fluidic components for spreading the at least two fluidic components from separately stored components to a granular ballast bed of a railway track at a site of use according to claim 16, further comprising at least two separate wagons drivable on rails and having gauge-changeable rail wheels (24), said wagons being road-transportable in their entirety in an associated single road vehicle or road trailer, which said drivable wagons are able to be coupled using a drawbar in a tension-locking manner and connectable to hoses and cables, wherein a first wagon of said at least two separate wagons is a container and said spray wagon has catch basins for inserting and heating the separate containers with the fluidic components to be used and mixed and including pumping means, mixing means and controlled discharging means of the components from the containers via flexible hose lines via a spray unit, and the second wagon of said at least two wagons is equipped with a diesel power generator for the power supply and having a starter battery and a control unit for electrically operated components.

19. The apparatus for transporting multi-component adhesives of at least two fluidic components for spreading the at least two fluidic components from separately stored components to a granular ballast bed of a railway track at a site of use according to claim 16, further comprising at least three separate wagons drivable on rails and having gauge-changeable rail wheels, said at least three separate wagons being road-transportable in their entirety in an associated single road vehicle or road trailer, which is able to be coupled in a tension-locking manner using drawbars and is connectable to hoses and cables, wherein a first wagon of said at least three separate wagons is a spray wagon having pumping means, mixing means and controlled discharging means of the components via flexible hose lines to a spray unit, a second wagon of said at least three separate wagons is a container wagon having catch basins for inserting and heating the separate containers with the fluidic components to be used and mixed, and a third wagon of said at least three separate wagons is equipped as a power supply wagon and having a power supply with a diesel power generator with a starter battery and a control unit for all electrically operated components.

20. The apparatus for transporting multi-component adhesives of at least two fluidic components for spreading the at least two fluidic components from separately stored components to a granular ballast bed of a railway track at a site of use according to claim 16, wherein said spray unit on the spraying wagon has a spraying bar running transversely to a direction of travel of said wagon on an outside of said wagon, which is horizontally and vertically moveable by motor control and mounted rotatable in all directions on a cantilever extending transversely beyond a width of said wagon and having a plurality of nozzles for creating different spray patterns, and said container wagon has a self-regulating heater for the interior of the catch basins for maintaining the components at a set temperature, and batteries for storing electric power, wherein said control unit is programmable in memory for different application programs and for supplying and controlling the heating device and gear pumps for the components, movement of the spray nozzles and control devices with having sensors.

21. The apparatus for transporting multi-component adhesives of at least two fluidic components for spreading the at least two fluidic components from separately stored components to a granular ballast bed of a railway track at a site of use according to claim 16, wherein said road vehicle for transport of said apparatus by road is a self-propelled low-bed vehicle transporter or a double-axle road trailer having a loading area for vehicle transport and steel cable winch, wherein the loading area is electrically or hydraulically downwardly inclinable to the rear and having rails on the loading area, and wherein further rails are extendable or pivotable to the rear beyond the loading area in an inclined position of the loading area, so that their rear ends are supported on the floor or on the rails of a stretch of rails running on the ground, whereby said wagons are able to be pulled on the loading area over the rails by their rail wheels into the trailer via steel cable winch and able to be lowered in an opposite direction onto a stretch of rails on the ground.

22. The apparatus for transporting multi-component adhesives of at least two fluidic components for spreading the at least two fluidic components from separately stored components to a granular ballast bed of a railway track at a site of use according to claim 16, wherein said spraying wagon comprises feed lines for conveying the fluidic components and a mixer unit for mixing the fluidic components to form an adhesive mixture, and wherein said feed lines are equipped with a controllable gear pump for controlling the flow rate and with a mass flow meter for the fluidic component through a respective said feed line, and the control unit is has a total flow rate or a mixing ratio between the fluidic components that is able to be maintained on the basis of the recorded flow rates via at least one output variable.

23. The apparatus for transporting multi-component adhesives of at least two fluidic components for spreading the at least two fluidic components from separately stored components to a granular ballast bed of a railway track at a site of use according to claim 22, said control unit has a total delivery rate and the mixing ratio between the fluidic components that is able to be regulated with said control unit via at least two output variables.

24. The apparatus for transporting multi-component adhesives of at least two fluidic components for spreading the at least two fluidic components from separately stored components to a granular ballast bed of a railway track at a site of use according to claim 22, wherein said control unit provides that the flow rates of the two fluidic components are able to be controlled as a function of travel speed that is able to be determined via a travel speed sensor included for said spraying wagon.

25. The apparatus for transporting multi-component adhesives of at least two fluidic components for spreading the at least two fluidic components from separately stored components to a granular ballast bed of a railway track at a site of use according to claim 16, wherein said spray bar comprises a plurality of spray nozzles able to produce a either a flat or conical spray pattern.

26. An apparatus for discharging multi-component adhesives of at least two fluidic components from separately stored components onto a granular ballast bed of a railway stretch of rails, comprising at least two wagons drivable on rails with gauge-changeable rail wheels, said at least two wagons being road-transportable in a single road vehicle or road trailer, able to be coupled using drawbars in a tension-locking manner and connectable to hoses and cables, wherein one of said wagons is a spray wagon with means for pumping, mixing and controlled discharging of the components via flexible hose lines to a spray unit having a spray bar, and an additional wagon comprising at lest two containers standing in catch basins and containing the transportable fluidic components to be used and mixed, and a diesel power generator with 400 V for the power supply and a control unit for the electric control, said apparatus includes a vehicle comprising a downwardly tiltable loading area in a rear portion thereof, on which loading area rails are extendable to the rear portion and beyond the end of the loading area, so that said wagons are pullable onto the loading area on said rails and are able to be placed in an opposite direction onto the tracks of a stretch of rails.

27. A method for operating an apparatus for transporting multi-component adhesives of at least two fluidic components for spreading the at least two fluidic components from separately stored components to a granular ballast bed of a railway track at a site of use, and for carrying along and discharging said multi-component adhesives at the site of use onto the granular ballast bed of the railway stretch of rails, said apparatus for transporting multi-component adhesives being road transportable and rail-suitable by comprising either a rail-suitable road vehicle or at least one road-transportable rail vehicle with a road vehicle or road trailer belonging to the device for transport by road, with gauge-changeable rail wheels, and wherein said road or rail vehicle comprises provides for the electric power supply and control for pumping the components via gear pumps, for their mixing and for their controlled discharge as multi-component adhesive via a spray unit belonging to the apparatus, which includes a spray bar and is mounted on one of said vehicles for serving as a spray wagon, said components being pumpable from at least two separate containers which are able to be carried in catch bins on said rail-suitable road vehicle or on one of said road-transportable rail vehicle of the apparatus, wherein the components are able to be pumped via flexible hose lines, each by a gear pump and a mass flow meter to a mixer and then to said spray bar, and wherein said spray bar is horizontally and vertically movable in an automatically controlled motor-driven manner at said spray wagon and being mounted rotatable in all directions on a cantilever extending across a width of the vehicle of said spraying wagon, for the speed-dependent controlled spreading of the adhesive mixture in a plurality of selectable spray patterns, said method comprising the steps of:
self-propelling the rail-compatible road vehicle said wagons for transport on a single vehicle or trailer to the place for use and, at the place for use, the rail-compatible road vehicle is driven onto a rail line, or the road vehicle is brought into operation, and the road trailer is brought into position on the rail line and wagons are then set down on rails of a rail line and coupled together in a force-locking and hinged manner via draw-bars and put into operation by controlled pumping, mixing and discharge of the adhesive.

28. The method for operating an apparatus for transporting multi- component adhesives of at least two fluidic components for spreading the at least two fluidic components from separately stored components to a granular ballast bed of a railway track at a site of use according to claim 27, wherein, while the adhesive is being discharged, the flow rates of the fluidic components are detected by continuously measuring the flow rates in the control unit of the apparatus and compared by comparing the measured data with a defined setpoint and at least one output variable with an output signal for controlling the total delivery rate of the gear pumps or the mixing ratio of the fluidic components for continuously monitoring the discharge.

29. The method for operating an apparatus for transporting multi-component adhesives of at least two fluidic components for spreading the at least two fluidic components from separately stored components to a granular ballast bed of a railway track at a site of use according to claim 28, wherein the ratio of the flow rates of the fluidic components is controlled by continuous comparison with a ratio setpoint stored in the control unit, and at least one of the first or the second output variable is adapted by the control unit as a function of a difference between the determined ratio and the ratio setpoint, and the output value is used to control the gear pumps and their flow rates or, in the event of a deviation of the determined flow rates or a deviation of the ratio of the determined flow rates by more than a predetermined maximum value of a deviation, the discharge or conveying of the fluidic components is automatically stopped by the control unit by stopping the gear pumps and closing the pneumatic valves.
